(19) United States
(12) Patent Application Publication
(10) Pub. No.: US 2023/0044506 A1
(43) Pub. Date: Feb. 9, 2023

(54) FUEL/DIESEL EXHAUST FLUID COMBINATION AUXILIARY TANK

(71) Applicant: Anthony Kelly, Macomb, MO (US)

(72) Inventor: Anthony Kelly, Macomb, MO (US)

(21) Appl. No.: 17/396,040

(22) Filed: Aug. 6, 2021

(51) Int. Cl. B60K 15/035; F01N 3/20

(52) U.S. Cl. CPC B60K 15/035; F01N 3/2066; F01N 2610/1406; B60K 2015/03118

(57) ABSTRACT

A diesel fuel and DEF combination tank provides a supplemental storage of diesel fuel and DEF for a vehicle. In particular, the combination tank comprises a first compartment for diesel fuel and a second compartment for DEF. Each compartment is provided with a respective outlet port for dispensing the fuel from the combination tank. Dispensing of fluid to the vehicle's fuel system is conducted by gravity feed or alternatively by pumping.

### FIELD OF THE INVENTION

The presently disclosed subject matter relates to fuel tanks for use in vehicles, primarily auxiliary fuel tanks used in pickup trucks. In particular, the subject matter relates to providing a supplemental tank for carrying diesel exhaust fluid (DEF) to complement an auxiliary diesel tank carried in the bed of a utility or pickup truck.

### BACKGROUND OF THE INVENTION

When driving a vehicle to remote locations there exists the concern of where fueling stations might be so that the danger of running out of fuel during the journey can be avoided. Similarly, as one operates their vehicle at remote locations for an extended time, there is the concern that adequate fuel reserves be provided. This is a situation typically faced by utility trucks that are dispatched to remote locations to respond to natural disasters to provide rescue, repair and maintenance duties. This is not a problem unique to utility trucks and those operating ordinary pickup trucks face similar issues.

A common solution to these issues is to provide an auxiliary fuel tank in the bed of the vehicle. There exist many aftermarket auxiliary reserve fuel tanks that can be retrofitted on to the vehicle and placed, for instance, in the bed of a pickup truck. As is well known in the art, fuel lines from the auxiliary tank can be connected to the fuel tank of the vehicle through various means. Fuel from the auxiliary tank can be gravity fed to the vehicle's fuel tank or may be delivered by a pump mechanism.

Diesel trucks are commonly provided with a reservoir for receiving diesel exhaust fluid (DEF) that feeds DEF into the vehicle's emission system to reduce carbon dioxide emissions. The port for filling the DEF reservoir on the original equipment vehicle is typically placed adjacent to the port for filling diesel fuel into the vehicle. The vehicle operator can simply fill the DEF reservoir with DEF at the time of filling of the diesel tank, or at other times as necessary. The vehicle is typically equipped with appropriate gauges on the vehicle's general instrument panel to indicate when the DEF levels may need to be replenished.

The supply of DEF in the vehicle's reservoir can run low for the same reasons discussed above when traveling to, or operating in, remote locations. The typical aftermarket diesel fuel auxiliary tank is limited to diesel fuel and has no additional capacity for storing and dispensing DEF. If it is desired to carry a supplemental supply of DEF, it generally must be provided in a separate container. Cargo space in a truck bed is limited and is quickly filled up by necessary equipment. An extra fuel container can take up space that a user would rather have for other necessary equipment. Also, a separate DEF container can be easily forgotten and be overlooked when loading and inadvertently fail to be loaded.

It would therefore be desirable to provide a supplemental auxiliary DEF tank that can be mounted adjacently to the auxiliary reserve fuel tank to provide a ready supply of DEF to the vehicle as the vehicle expends the DEF in the main DEF reservoir in the vehicle.

### SUMMARY OF THE INVENTION

The present invention provides a diesel fuel and DEF combination tank to provide a supplemental storage of diesel fuel and DEF for a vehicle. In particular, the invention comprises a combination tank having a first compartment for diesel fuel and a second compartment for DEF. The combination tank is adapted for placement in the storage bed of a utility truck or a pickup truck.

Each compartment is provided with an outlet port for dispensing the fuel from the combination tank. To enable a simple gravity feed of fluid from the combination tank, dispensing ports are placed at the respective lower ends of each of the diesel fuel and DEF compartments. Appropriate fuel conveying lines are used to carry the fluids to the vehicle's fuel entry ports using conventional connection attachments. Alternatively, the fuel from the combination tank may be dispensed with the aid of a pump.

These and other features of the present invention are described in greater detail below in the section titled DETAILED DESCRIPTION OF THE INVENTION.

### BRIEF DESCRIPTION OF THE DRAWING FIGSURES

The present invention is described herein with reference to the following drawing figures, with greater emphasis being placed on clarity rather than scale:

FIG. 1 is a perspective view of a prior art supplemental diesel fuel tank for the back of a pickup truck.

FIG. 2 is a top plan view of the combination diesel fuel/DEF tank of the present invention.

FIG. 3 is a view in side elevation taken from the side of the combination diesel fuel/DEF tank.

FIG. 4 is a cross-sectional view taken along the lines 4-4 in FIG. 3.

FIG. 5 is a view in side elevation of the combination diesel fuel/DEF tank.

FIG. 6 is a view in side elevation of the combination diesel fuel/DEF tank.

FIG. 7 is a perspective view of the combination diesel fuel/DEF tank positioned in the bed of a truck.

FIG. 8 is a perspective view showing the DEF compartment of the combination tank apart from the diesel fuel compartment.

### DETAILED DESCRIPTION OF THE INVENTION

With reference to the drawings figures, a combination diesel fuel/DEF tank is herein described, shown, and otherwise disclosed in accordance with various embodiments, including a preferred embodiment, of the present invention.

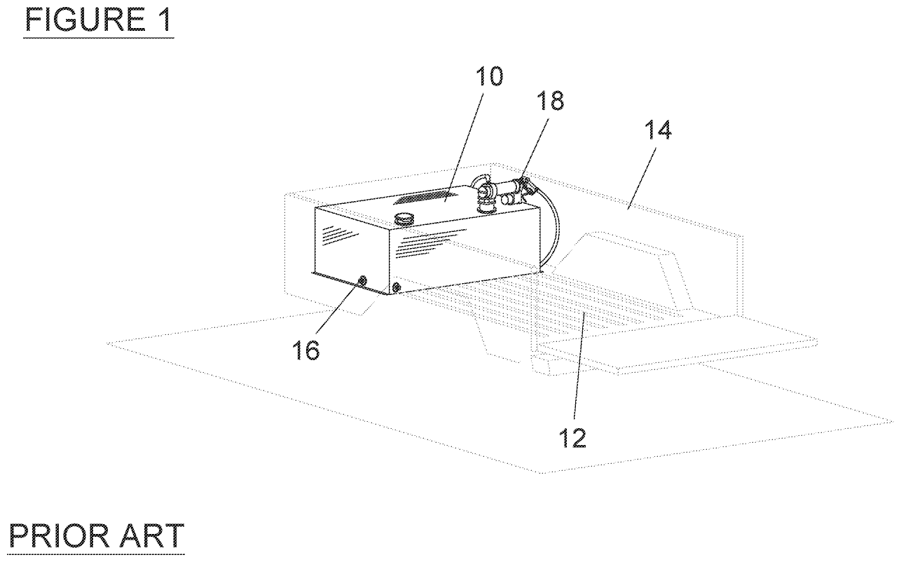

To provide context for the structure and function of the invention, a conventional prior art auxiliary diesel tank 10 for placement in the bed 12 in the back of a pickup truck 14 is shown in FIG. 1. The auxiliary tank is provided with a dispensing port 16 to permit a gravity feed flow from the tank to the fuel line of the truck. The auxiliary tank can be provided with a pump 18 as a means for delivery of the diesel fuel from the auxiliary tank. The means for connecting the lines feeding diesel fuel from the auxiliary tank to the fuel lines of the truck, whether by gravity feed or by pump, are well known to those having ordinary skill in the art.

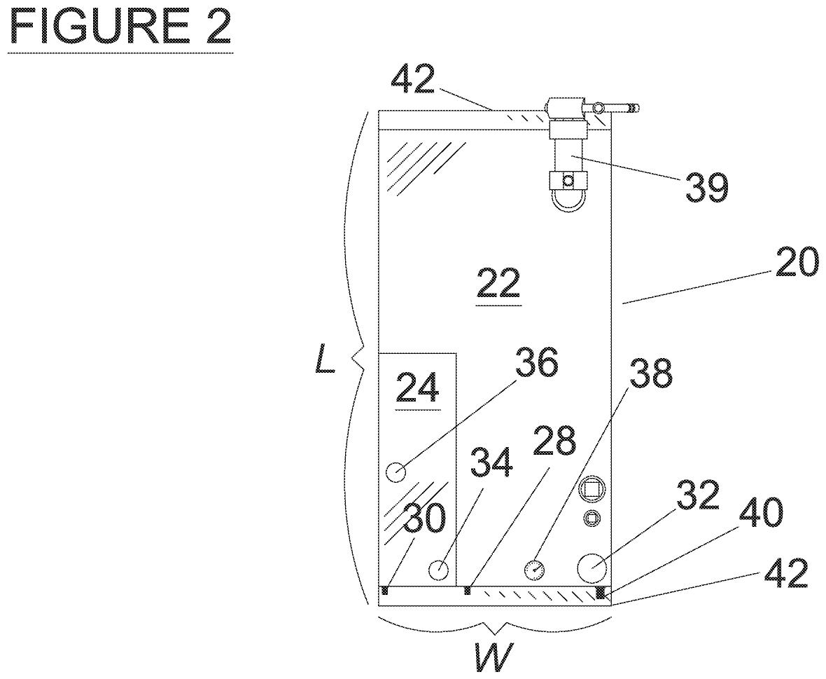

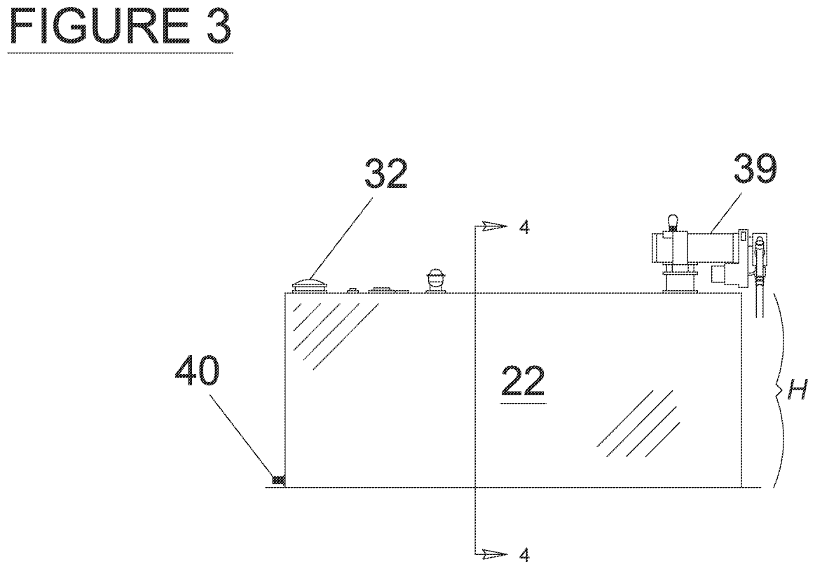

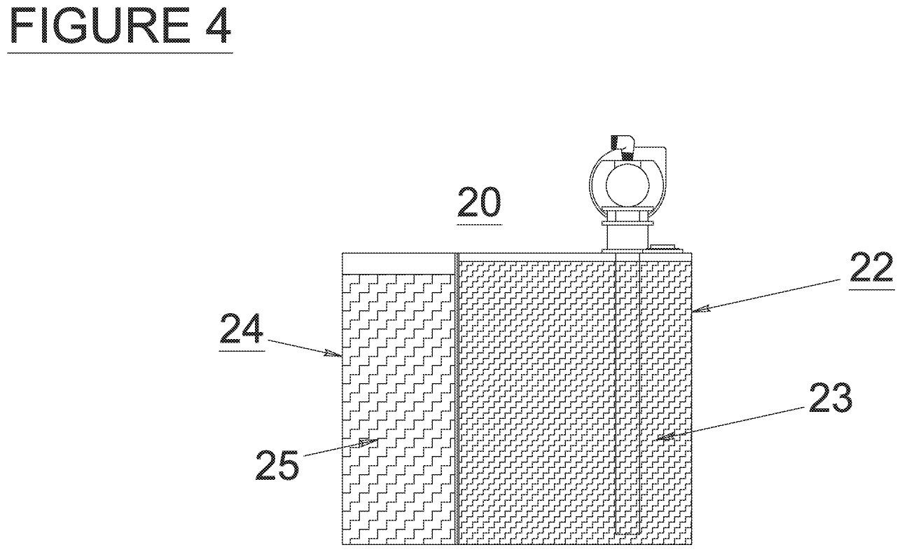

An embodiment of the fuel/diesel exhaust fluid (DEF) combination auxiliary tank 20 of the present invention is shown in FIGS. 2-6. Auxiliary tank 20 comprises a first compartment 22 for containing diesel fuel 23 and a second compartment 24 for containing DEF 25. Separate compartments are required to prevent mixing of the diesel fuel with the DEF. The respective dimensions of first compartment 22 and second compartment 24 may vary, but generally, because the vehicle will consume a larger quantity of diesel fuel compared to DEF, the compartment containing diesel fuel will necessarily be substantially larger than the compartment containing DEF. In a preferred embodiment, compartment 22 for containing diesel fuel will have a capacity of about 81 gallons and compartment 24 for containing DEF will have a capacity of about 17 gallons. Tank 20 has an overall length of about 47 inches along its length “L”, an overall width of about 24 inches along its width “W”, and a height of about 20 inches along its height “H” as shown in FIGS. 2 and 3. Notwithstanding these recited dimensions, the combination tank can have different overall dimensions, and the respective capacities of the diesel compartment and the DEF compartment can vary as desired.

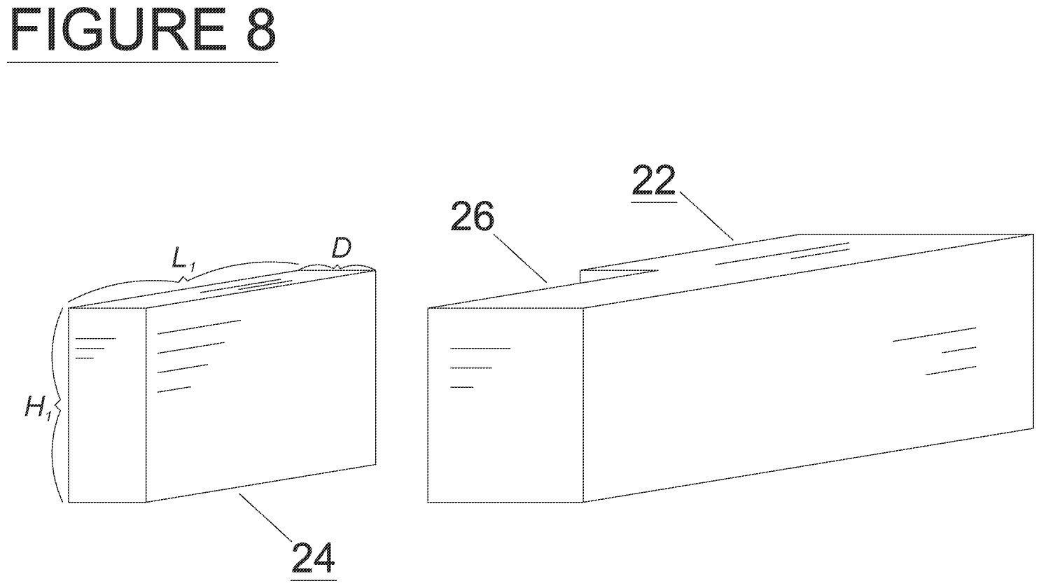

Tank 20 is configured to have an overall rectangular shape formed by the complementary configuration of compartments 22 and 24. This configuration makes efficient use of the limited space available in the bed of a truck. As shown in FIG. 2 and FIG. 8, compartment 22 is constructed with an L-shaped configuration to provide a cut-out area to receive compartment 24. In an embodiment, compartment 24 has a depth “D” of 8 inches, a length “L1” of 24 inches, and a height “H1” of 20 inches as shown in FIG. 8. The cut-out area 26 of compartment 22 has corresponding dimensions such that compartment 24 is received within cut-out area 26.

Due to the corrosive nature of DEF, which can corrode certain metals, compartment 24 should be constructed of stainless steel which is resistant to the corrosive effects of DEF. As a possible alternative, DEF compartment 24 may be comprised of other materials that are resistant to the corrosive effects of DEF, such as plastic. Compartment 22 for containing diesel fuel can be constructed of any metal or plastic. If both compartments are composed of metal (ensuring stainless steel for the DEF compartment), then they may be joined by welding. Other means of connecting may be used (such as by brackets) depending upon the material of which the compartments are constructed. Tank 20 has mounting flange brackets 42 at a lower end thereof to permit the tank to be fastened by bolts or the like to the truck bed.

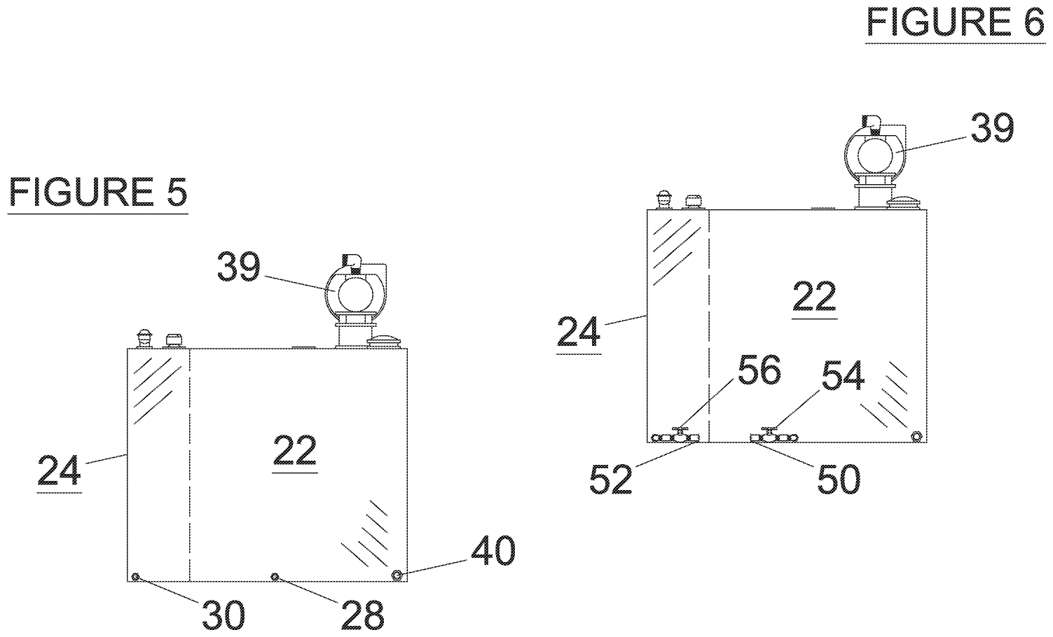

Each of compartments 22 and 24 are provided with filling ports 32 and 34 at their top surfaces as shown in FIG. 2. Compartment 24 has a vent outlet 36 to vent DEF fumes. Compartment 22 has a fuel level gauge 38. Each of compartments 22 and 24 are provided with outlets 28 and 30 towards their respective lower ends, shown in FIG. 5, to permit dispensing of fluid by gravity feed. Compartment 24 is provided with a pump head 39 to facilitate dispensing of diesel by pump means. Compartment 22 has drain outlet 40 for draining diesel fuel.

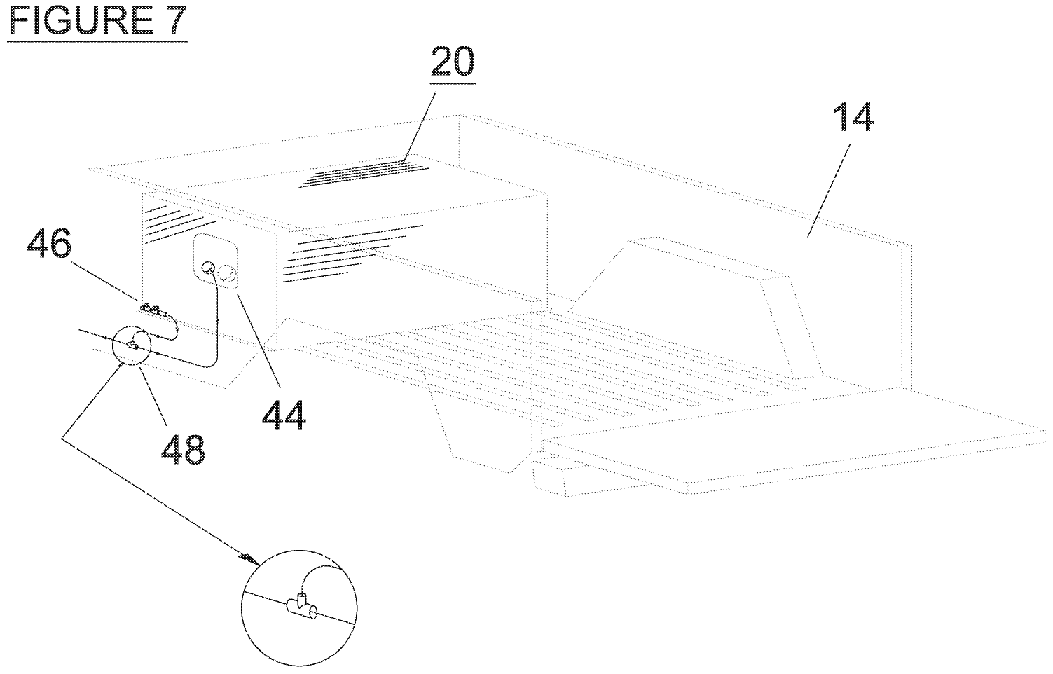

The dispensing of diesel fuel and DEF from the combination diesel fuel/DEF auxiliary tank to the truck's fuel lines is arranged similarly to that carried out by auxiliary tanks of the prior art and is known to those skilled in the art. FIG. 7 schematically shows dispensing of fluid from the combination diesel fuel/DEF auxiliary tank 20 to a truck's fuel system 48 alternatively through a pump arrangement 44 and a gravity feed 46. Fuel lines 50 and 52 lead respectively from dispensing ports 28 and 30 of diesel compartment 22 and DEF compartment 24 in dispensing fluid by gravity feed. Each of fuel lines 50 and 52 are provided with valves 54 and 56 respectively for controlling the flow of fluid through the gravity feed.

Although the invention has been disclosed with reference to various particular embodiments, it is understood that equivalents may be employed and substitutions made herein without departing from the scope of the invention as recited in the claims.

Having thus described the preferred embodiment of the invention, what is claimed as new and desired to be protected by Letters Patent includes the following:

1. A combination diesel fuel and DEF tank for providing a supplemental supply of diesel fuel and DEF to a fuel and exhaust system of a vehicle, said combination tank comprising a first compartment for containing diesel fuel, and a second compartment for containing DEF, each of the first and second compartments having respective dispensing ports, each of the dispensing ports being adapted for connection to respective feeder lines for delivery of the supplemental supply of diesel fuel and DEF to the fuel and exhaust system of the vehicle.

2. The combination diesel fuel and DEF tank of claim 1 in which the second compartment is comprised of stainless steel.

3. The combination diesel fuel and DEF tank of claim 2 in which the first compartment is comprised of metal, and the first and second compartments are welded together.

4. The combination diesel fuel and DEF tank of claim 2 in which the first and second compartments are bolted together.

5. The combination diesel fuel and DEF tank of claim 1 in which the dispensing port of the second compartment is provided with a shutoff valve movable between an open and a closed position to permit a gravity feed flow of DEF through its feeder line.

6. The combination diesel fuel and DEF tank of claim 1 in which the second compartment containing the DEF has a vent opening.

7. The combination diesel fuel and DEF tank of claim 1 in which a bottom edge of the combination tank has laterally extending flanges with apertures for receiving fasteners whereby the combination tank is adapted for being secured to a surface of a bed of the vehicle.

8. The combination diesel fuel and DEF tank of claim 1 in which a portion of a wall of the first compartment for containing diesel fuel is recessed inward, the second compartment for containing DEF being received in the recessed portion of the first compartment adjacent to an exterior surface of the wall of the first compartment.
